(19) United States
(12) Patent Application Publication
(10) Pub. No.: US 2010/0228609 A1
(43) Pub. Date: Sep. 9, 2010

(54) Electronic transcript generator

(76) Inventor: Steven Marcus, Valencia, CA (US)

Correspondence Address: TOPE-MCKAY & ASSOCIATES;CARY TOPE-MCKAY, 23852 Pacific Coast Highway # 311, Malibu, CA, 90265, US

(21) Appl. No.: 12/380,904

(22) Filed: Mar. 5, 2009

(51) Int. Cl. G06Q 30/00; G06Q 10/00; G06Q 50/00; G06Q 20/00

(52) U.S. Cl. 705/14.4; 705/400; 705/410; 705/34; 705/26; 705/40

(57) ABSTRACT

An electronic transcript generation and transfer system is described. It contains functionality for facilitating transactions between requestors and reporters by receiving a request for a transcript quote from a requestor and providing the request to a reporter. The system provides the reporter an interface to associate a number of pages with the request and based on various factors, generates a communication with the requestor containing the quote. The system then facilitates the requestor's payment for the transcript and provides the reporter a work request with specific details about the transcript request. Finally, upon receipt of the transcript sent notification from the reporter, the system transfers the requestor's payment to the reporter and transmits a communication to the requestor containing tracking information and other details of the completed transcript request.

### BACKGROUND OF THE INVENTION

(1) Field of Invention

The present invention relates to a system for electronically generating transcripts and, more particularly, to a system that electronically facilitates requesting, docketing, fulfillment of, and payment processing for transcripts.

(2) Description of Related Art

Systems related to the tracking of transcripts have long been known in the art. Generally, systems that handle the tracking of large amounts of transcripts require a substantial amount of administrative staff involvement and supervision. A typical system involves having administrative staff contact reporters by phone or email and then using the office's built in scheduling systems to set up appointments. It further involves establishing some type of list or database to assist the administrative staff in keeping track of which reporter is supposed to be at a particular location at a particular time. Once the meeting occurs, payment typically is handled by the reporter's payment method of choice. These multiple payment methods must all be tracked by some sort of list or database by the administrative staff. Finally, the number and type of transcripts requested and methods and times of delivery of the transcripts must also be tracked by the administrative staff, often with the assistance of another list or database. These separate steps and multiple tracking systems lead to increased errors and high costs for what should be a simple administrative function.

A similar situation exists for the reporters. Reporters typically use some sort of scheduling system to set up appointments, another system to facilitate payment for services rendered and another system to track what type of transcripts are requested, when those transcripts are due, and whether orders have been fulfilled. The various steps to perform and issues to track lead to increased errors and additional costs for the reporter.

A system that tracks all of the details associated with the transcript generation process for both the transcript requesters and the reporters while simultaneously facilitating communication between these two parties would reduce the workload and reduce costs by simplifying workflow, improving communication, and reducing the chance of errors.

Thus a continuing need exists for a system that can facilitate communication between transcript requesting and transcript producing parties, as well as track details of these communications while simultaneously reducing workload and reducing costs.

### SUMMARY OF INVENTION

The present invention has three principle aspects. The first is a computer program product comprising computer-readable instructions stored on a computer-readable medium that is executable by a computer having a processor which causes the processer to perform operations. The second is a system for transferring transcripts, the system having one or more processors that are operable for performing acts and operations. The third is a method for transferring transcripts, the method comprising an act of causing a processor to perform the acts and operations. The acts and operations which will be described are similar for any one of these three principle aspects.

One aspect of the present invention relates to a computer program product for transferring transcripts, the computer program product comprising computer-readable instructions stored on a computer-readable medium that are executable by a computer having a processor for causing the processor to perform operations of: receiving a request for a transcript quote from a requestor, the request including case information selected from a group consisting of a case name, a case number, a date and a department/location; generating a communication to a reporter with the request; providing the reporter an interface in which the reporter can associate a number of pages with the requested transcript quote; determining a cost based on a cost factor selected from a group consisting of page count, delivery speed options, number of copies and type of delivery; generating a communication to the requester, the communication including information selected from the group consisting of cost information, payment information and payment method information; receiving notification of payment for the transcript; providing the reporter a work request with delivery information selected from a group consisting of, due date, delivery location, delivery speed options, number of copies, type of delivery, and address label with pre-printed postage; receiving a transcript sent communication from the reporter; transferring transcript fees to the reporter upon receipt of the transcript sent communication; and generating a communication to the requestor providing notification of the transcript being sent.

In yet another aspect, of the computer program product for transferring transcripts, while in the operation of providing the reporter with the address label with preprinted postage the computer program product further includes computer-readable instructions for causing the computer to perform the operation of calculating postage based on the recipient address and current postage rates and generating the address label.

In still another aspect, the transcript sent notification further includes tracking information and the communication to the requestor containing a transcript sent notification further includes tracking information as well.

In another aspect, the computer program product for transferring transcripts further includes computer-readable instructions for causing the processor to perform operations of generating a transcript tracker, including a plurality of current transcript requests and a plurality of completed transcript requests; whereupon sending of the transcript, the transcript tracker is updated to remove the transcript from the plurality of current transcript requests to the plurality of completed transcript requests.

In yet another aspect of the computer program product for transferring transcripts, the computer program product further includes computer-readable instructions for causing the processor to perform operations of providing a requestor interface, the requester interface including the transcript tracker, a sub-set of the completed transcript requests and a sub-set of the current transcript requests.

In another aspect of the computer program product for transferring transcripts, the computer program product further includes computer-readable instructions for causing the processor to perform operations of providing a reporter interface including the transcript tracker, a sub-set of the completed transcript requests and a sub-set of the current transcript requests.

In yet another aspect of the computer program product for transferring transcripts, the computer program product will further include computer-readable instructions for causing the processor to perform operations causing the reporter interface to further include a case information field and corresponding prospective requestor field, such that upon input of the case information and corresponding prospective requester information, the prospective requestor is provided a communication with an offer providing a quote for the transcript.

In another aspect of the computer program product for transferring transcripts, the requester interface further includes an advertising element.

In yet another aspect of the computer program product for transferring transcripts, the reporter interface further includes an advertising element.

Another aspect of the present invention relates to a system for transferring transcripts, the system perform operations of: a requestor sending a request for a transcript quote, the request including case information selected from a group consisting of a case name, a case number, a date and a department/location; receiving the request for the transcript quote from the requestor; generating a communication to a reporter with the request; providing the reporter an interface in which the reporter can associate a number of pages with the requested transcript quote; the reporter associating a number of pages with the requested transcript quote; determining a cost based on a cost factor selected from a group consisting of page count, delivery speed options, number of copies and type of delivery; generating a communication to the requestor, the communication including information selected from the group consisting of cost information, payment information and payment method information; the reporter receiving the communication; the requestor sending a notification of payment for the transcript; receiving the notification of payment for the transcript; providing the reporter a work request with delivery information selected from a group consisting of, due date, delivery location, delivery speed options, number of copies, type of delivery, and address label with pre-printed postage; the reporter preparing and sending the transcript; the reporter sending a transcript sent notification; receiving a transcript sent communication from the reporter; transferring transcript fees to the reporter upon receipt of the transcript sent communication; and generating a communication to the requester providing notification of the transcript being sent.

In another aspect, system for transferring transcripts further includes operations of generating a transcript tracker, including a plurality of current transcript requests and a plurality of completed transcript requests; whereupon the reporter sending the transcript, the transcript tracker is updated to remove the transcript from the plurality of current transcript requests to the plurality of completed transcript requests.

In yet another aspect of the system for transferring transcripts, the system further includes operations of a requestor interacting with a requestor interface, the requester interface including the transcript tracker, a sub-set of the completed transcript requests and a sub-set of the current transcript requests.

In yet another aspect of the system for transferring transcripts, the system further includes operations of a reporter interacting with a reporter interface, a reporter interface including the transcript tracker, a sub-set of the completed transcript requests and a sub-set of the current transcript requests.

In another aspect of the system for transferring transcripts, the requestor interface further includes an advertising element.

In yet another aspect of the system for transferring transcripts, the reporter interface further includes an advertising element.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a computer program product according to the present invention;

FIG. 2 is a block diagram, illustrating a system for electronic transcript generation;

FIG. 3 is a flow chart illustrating a system for electronically generating and transferring a transcript;

FIG. 4 is a flow chart illustrating a portion of the system for electronically generating and transferring a transcript;

FIG. 5 is a flow chart illustrating a portion of the system for electronically generating and transferring a transcript;

FIG. 6 is a flow chart illustrating a portion of the system for electronically generating and transferring a transcript;

FIG. 7 is a flow chart illustrating a portion of the system for electronically generating and transferring a transcript; and

FIG. 8 is a flow chart illustrating a portion of the system for electronically generating and transferring a transcript.

### DETAILED DESCRIPTION

The present invention relates to a system for electronically generating transcripts and, more particularly, to a system that electronically facilitates requesting, docketing, fulfillment of and payment processing for transcripts. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Note, if used, the labels left, right, front, back, top, bottom, forward, reverse, clockwise and counter-clockwise have been used for convenience only and are not intended to imply any particular fixed direction. Instead, they are used to reflect relative locations and/or directions between various portions of an object. As such, as the electronic transcript generation system is turned around and/or over, the above labels may change their relative configurations.

Before describing the invention in detail, an introduction is provided to provide the reader with a general understanding of the present invention. Next, a description of various aspects of the present invention is provided to give an understanding of the specific details.

(1) Introduction

The present invention has three “principle” aspects. In its first aspect, it is a computer program product that exists in a computer-readable form on a computer-readable medium that instructs a processor to perform the operations necessary to electronically generate and transfer transcripts. In its second aspect, it is a system for electronically generating and transferring transcripts. In its final aspect, it is a method for causing a processor to electronically generate and transfer transcripts.

In the description below the Electronic Transcript Generator will be generally referred to as the “System.” Whenever the System is discussed, that aspect or portion of the System is equally applicable to all three principle aspects. In the first sense, it will be applicable because it will be an aspect or portion of the computer program product that comprises an instruction in a computer-readable form on a computer-readable format for performing the operations necessary to electronically generate and transfer transcripts. In the second sense, the aspect or portion the System described will be applicable because it will be a part of the system for electronically generating and transferring transcripts. In the third sense, the aspect or portion of the System discussed will be applicable to the method because it will be describing an operation that the method will be causing the processor to perform.

(2) Principle Aspects

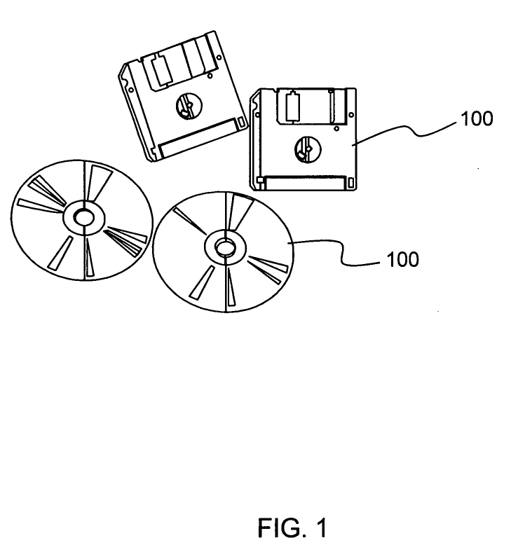

In the first principle aspect, the computer program product generally represents computer-readable instructions stored on a computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. The computer program product is typically in the form of a computer system operating software or in the form of a “hard-coded” instruction set. In this way it may be incorporated into a wide variety of devices that provide different functionalities. An illustrative diagram of a computer program product embodying the present invention is depicted in FIG. 1. The computer program product 100 is depicted as an optical disk such as a CD or DVD and as a magnetic storage disk. However, as mentioned previously, the computer program product generally represents computer-readable instructions stored on any compatible computer-readable medium.

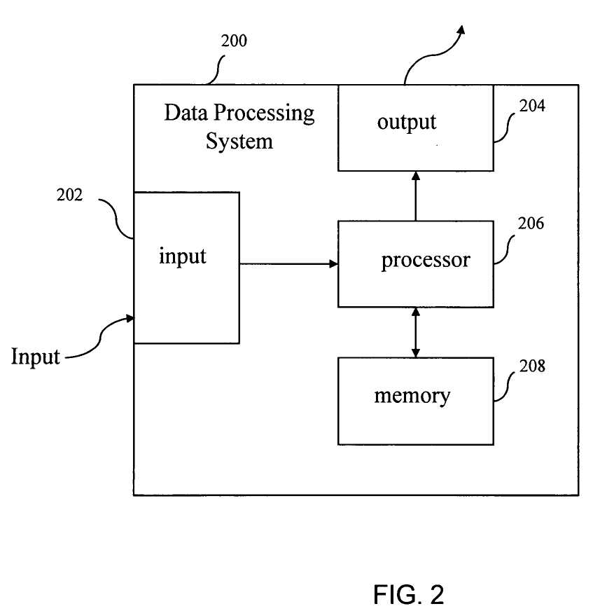

The second principle aspect of the Electronic Transcript Generator is a system that has one or more processors that are operable for performing operations which will effectuate the electronic generation and transfer of transcripts. A block diagram depicting the components of an Electronic Transcript Generator system of the present invention is provided in FIG. 2. The system 200 comprises an input 202 for receiving information regarding various transcripts and work requests. Note that the input 202 may include multiple “ports.” Typically, input is received from a user or other systems, a non-limiting example of which includes another computer that monitors requestor and reporter inputs, a terminal, etc. An output 204 is connected with the processor for providing information regarding the results of computations and functions to users and/or to other systems in order that a network of computer systems may serve as Electronic Transcript Generators. Output may also be provided to other devices or other programs; e.g., to other software modules, for use therein. The input 202 and the output 204 are both coupled with a processor 206, which may be a general-purpose computer processor or a specialized processor designed specifically for use with the present invention. The processor 206 is coupled with a memory 208 to permit storage of data and software that are to be manipulated by commands to the processor 206.

The third principal aspect is a method, typically in the form of software, operated using a data processing system (computer). Various portions, aspects, and examples of these three principle aspects will be described in more detail below.

(2.1) Detailed Description of the Electronic Transcript Generator

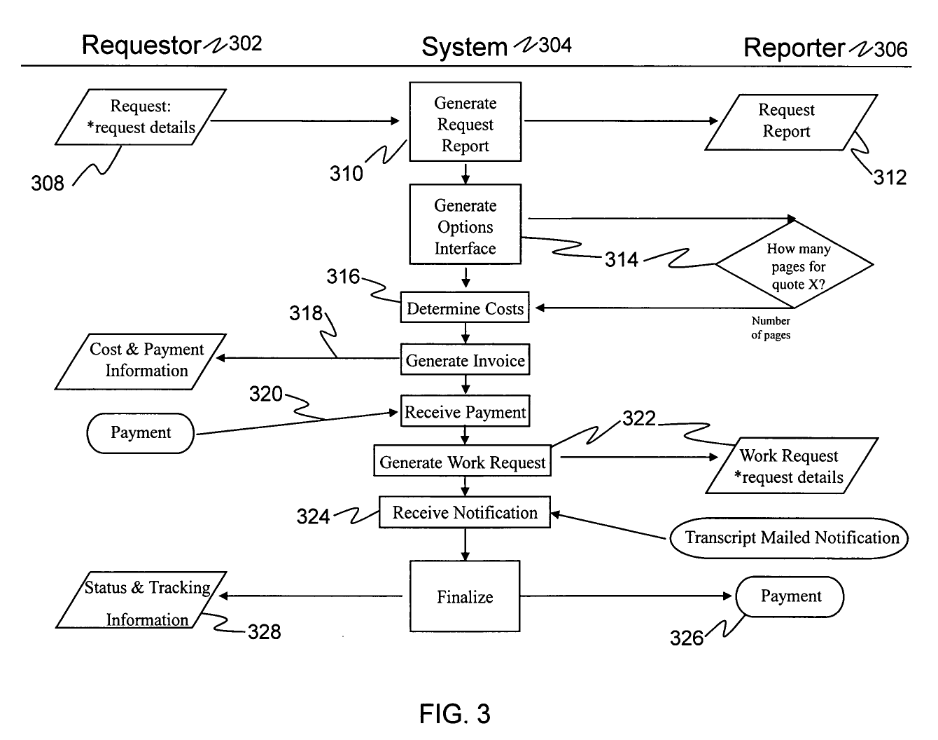

A non-limiting example of the System 304 in the present invention is depicted in FIG. 3. The first function involves the System 304 receiving a request 308 for a transcript quote from a Requestor 302. The request 308 can include case information selected from a group consisting of a case name, a case number, a date and a department/location. However, the case information is not limited to a single data item. It can include any data necessary to initiate the transcript generation and transfer process. Following that, the System 304 generates 310 a communication to a Reporter 306 with a request report 312. This request report 312 may contain any information the Reporter 306 needs, including, but not limited to, scheduling information, transcript duration, location, Requestor name, firm, etc.

After sending the request report 312, the System 304 provides the Reporter 306 an interface in which the Reporter 306 can associate a number of pages with the requested transcript quote 314. The System 304 takes this information and determines the cost 316 by selecting one or more cost factors and computing the cost. Possible non-limiting examples of cost factors include: page count, delivery speed options, number of copies and type of delivery. After costs are computed, the System 304 generates a communication 318 to the Requestor 302. The communication 318 includes, but is not limited to, cost and payment information. Following communication of costs 318, the System 304 provides an opportunity to receive payment 320 from the Requestor 302 for the transcript. To facilitate the payment process, the System 304 may incorporate any type of payment processing system ranging from a fully automated credit card payment processing system to a simple register of who payments have been received from and to whom they are going to be applied.

After payment 320 has been received, the System 304 must provide a reporter work request 322. The reporter work request 322 incorporates delivery information which provides the final details of the work requested by the Requestor 302. Non-limiting examples of work request details include, due date, delivery location, delivery speed options, number of copies, type of delivery, and address label with pre-printed postage. The System 304 then receives a transcript sent communication 324 from the Reporter 306. The communication 324 will include at least tracking information, but may include other data such as mailing date, sending method, etc. Upon receipt of the transcript sent communication 324, the System 304 completes the transaction by transferring the transcript fees 326 to the Reporter 306. Lastly, the System 304 generates a communication 328 to the Requestor 302, providing status and tracking information for the sent transcript.

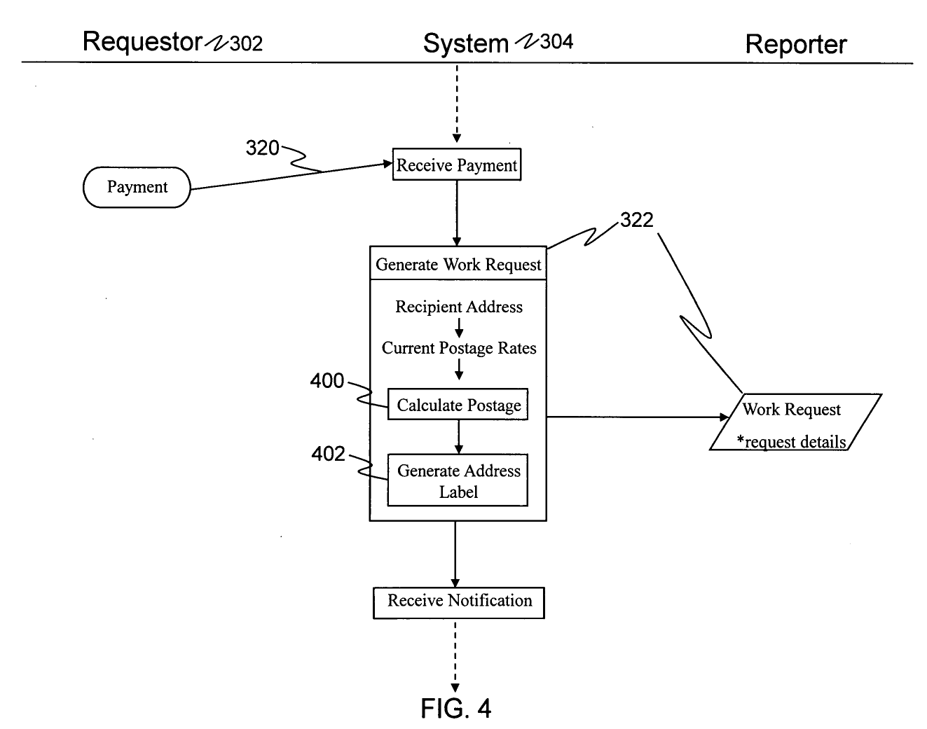

In FIG. 4, another aspect of the System 304 is illustrated. In this aspect, the function of providing the Reporter 306 with the address label with preprinted postage may further comprise an act of calculating postage 400 based on the recipient address and current postage rates and generating the address label 402. The recipient address can be obtained by the System 304 in any number of ways including, but not limited to, requesting the address from the Requestor 302 or looking it up in a database or directory. The current postage rates can be similarly obtained by referencing the shipping service's web site, or by looking them up in a directory or database.

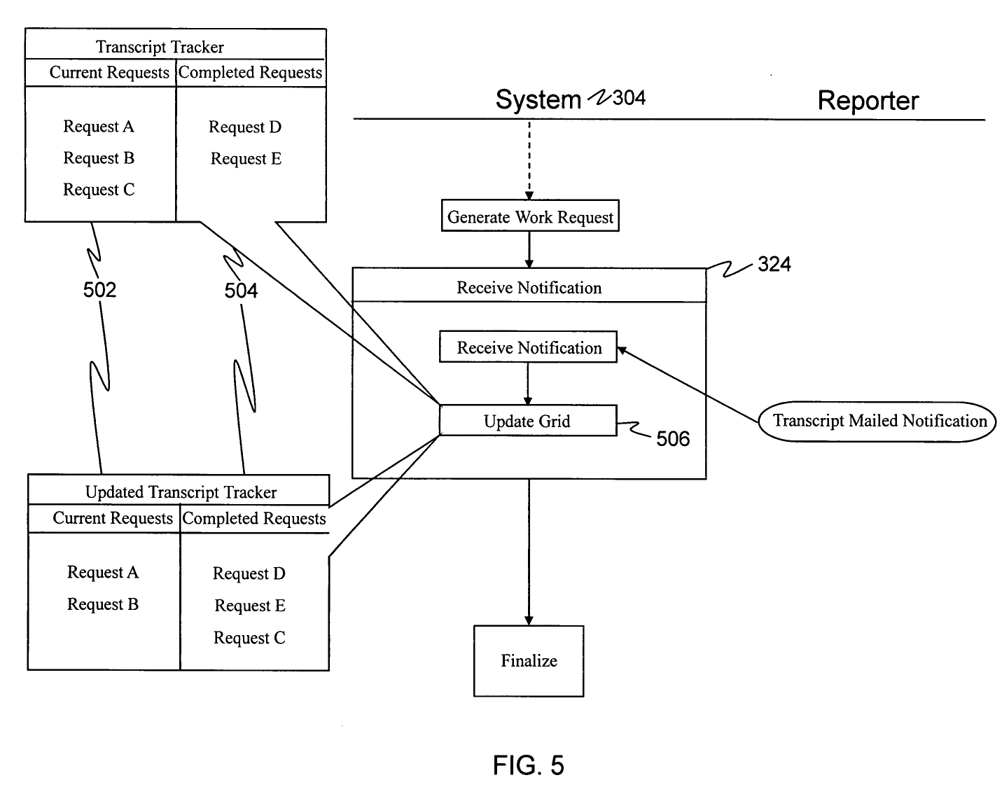

Yet another aspect of the System 304 is illustrated in FIG. 5. Here, the System 304 further comprises the function of generating a transcript tracker 500, including a plurality of transcript requests 502 whereupon sending of the transcript, the transcript tracker is updated 506 to remove the transcript from the plurality of transcript requests 502 and transferred to the completed transcript requests 504. This provides the System 304 with the functionality of tracking which requests have been fulfilled and which requests are still pending. To provide this functionality, the transcript tracker 500 is persistent relative to independent transcript requests. So, even though individual transcript requests may move from the request stage (see FIG. 3 items 308, 310, and 312) to the finalization stage (see FIG. 3 items 328 and 326), the transcript tracker 500 remains; serving as a means to track the status of individual transcript requests as they move from one stage to the next. The transcript tracker 500 is not limited to only tracking pending and completed requests. It may contain any information that will assist the Requestor (see FIG. 3 item 302) or Reporter (see FIG. 3 item 302) including, but not limited to, reporter/requestor contact information, details about each request, request histories, etc.

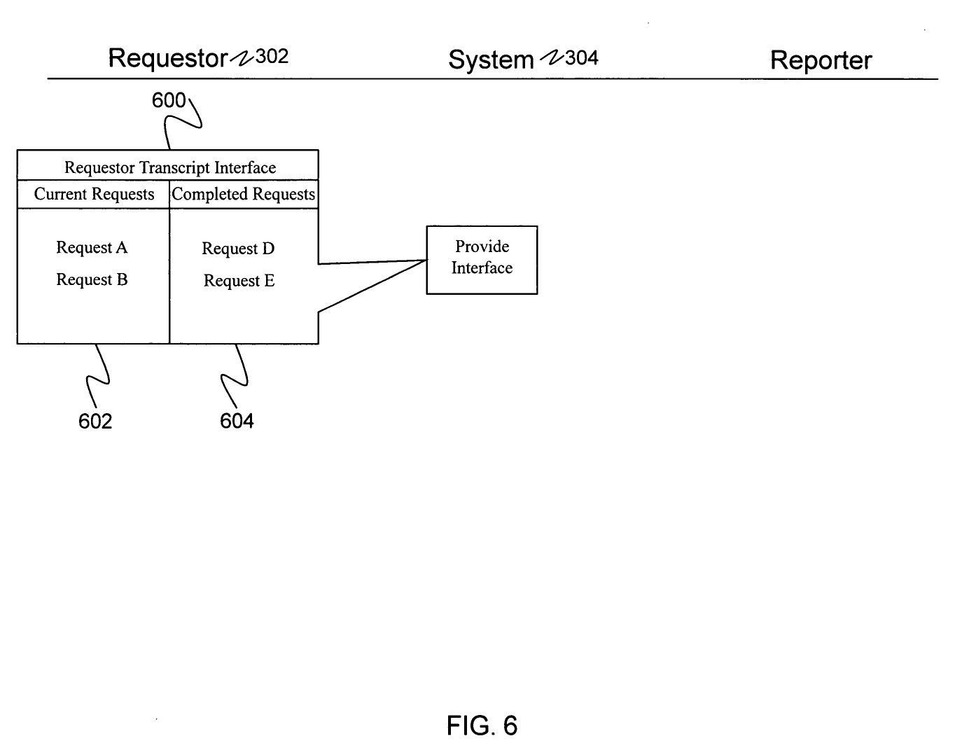

Another aspect of the System 304 is illustrated in FIG. 6. Here, the System 304 further contains functions for providing a requestor interface 600. The requestor interface 600 includes a sub-set of the completed transcript requests 602 and a sub-set of the current transcript requests 604. The requestor interface 600 can be any form that is suitable for the task of displaying and allowing the management of pending and completed transcript requests. Non-limiting examples of requestor interfaces include, graphical user interfaces, command line interfaces, registers, grids, etc. This requestor interface 600 provides the Requestor 302 with a means for managing and reviewing their pending and completed transcript requests. Similar to the transcript tracker, the requester interface 600 can display any information stored by the System 304 that will be beneficial to the Requestor 302 including, but not limited to, reporter contact information, details about each request, request histories, scheduling information, calendars, etc.

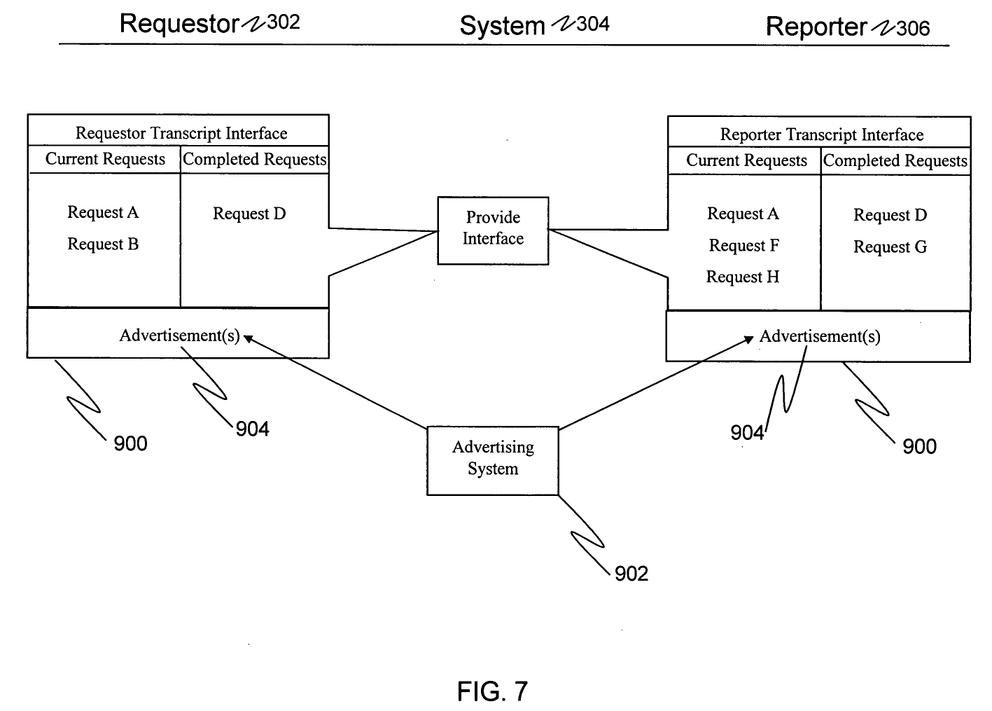

An additional aspect of the System 304 can be seen in FIG. 7. In this depiction the System 304 contains further functions that provide a reporter interface 700. The reporter interface 700 includes a sub-set of the completed transcript requests 704 and a sub-set of the current transcript requests 702. The reporter interface 700 can take any form that is suitable for the task of displaying and allowing the management of pending and completed transcript requests. Non-limiting examples of reporter interfaces include, graphical user interfaces, command line interfaces, registers, grids, etc. This reporter interface 700 provides the Reporter 306 with a means for managing and reviewing their pending and completed transcript requests. The reporter transcript interface 700 and requestor transcript interface (see FIG. 6 item 600) serve vital roles in the system and provide substantial enhancements over the state of the art, reducing costs by reducing workload and reducing errors by centralizing and streamlining the workflow.

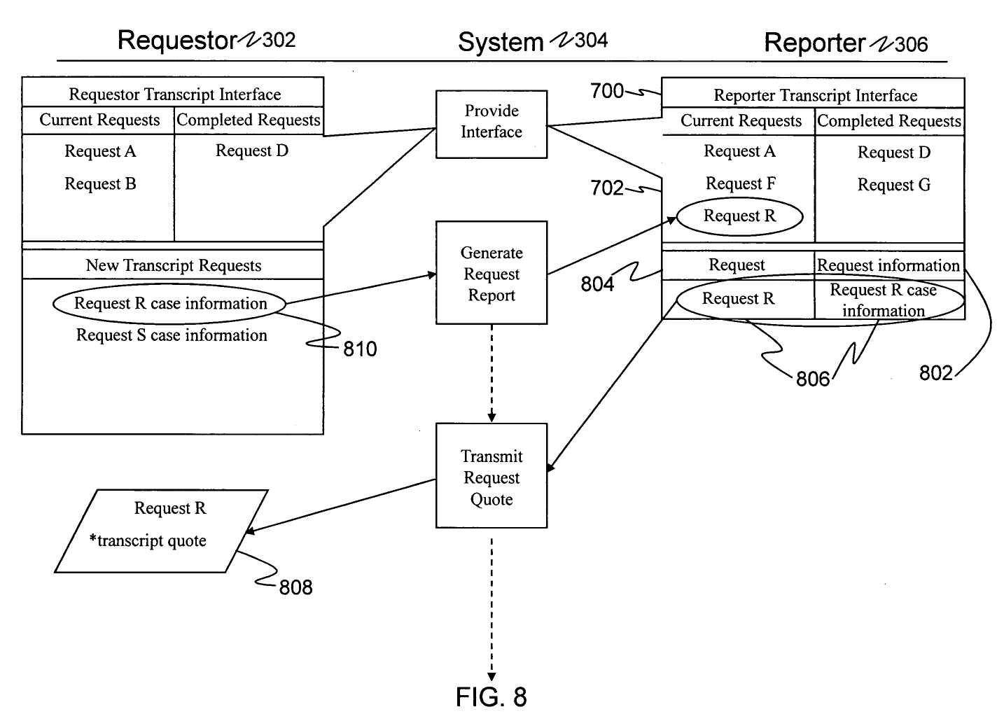

Another aspect of the System 304 can be seen in FIG. 8. This depiction shows another example of an additional System 304 function. FIG. 8 depicts how the reporter interface 700 may further comprise a case information field 802 and corresponding prospective requestor field 804. Upon input of the case information and corresponding prospective requestor information 806, the prospective Requestor 302 is provided a communication 808 with an offer containing a quote for the transcript. As can readily be seen by one skilled in the art, the prospective Requestor 302 can either be an existing Requestor 302 with existing transcript requests (as depicted in FIG. 8), or they can be an entirely new prospective Requestor 302, with no preexisting transcript requests (not depicted). The functionality to perform the transaction depicted in FIG. 8 allows for a prospective Requestor 302 to enter information about a needed transcript 810. The System 304 then generates a request report, which is eventually displayed in the reporter transcript interface's 700 current transcript requests 702. Upon entry of the case information and requestor information 806, the System 304 will generate a quote communication 808. The quote communication 808 can be generated using any number or combination of methods including, but not limited to, an estimate provided by Requestor 302, a calculation performed by the system based on the Reporter's 306 stated rates and the Reporter's 306 estimated page count, or a calculation based on delivery speed options, number of copies and type of delivery, etc.

Another aspect of the system 304 can be seen in FIG. 9, which depicts another feature of the reporter interface 700 and the requester interface 600. Both the reporter interface 700 and/or the requestor interface 600 may incorporate an advertising element 900. The advertising element 900 is supported by an advertising system 902 that provides one or more advertisements 904 to the advertising element 900. The system 304 presents the advertisements 904 to the reporter 306 and the requestor 302. The advertisements may 904 be of any type the system 304 is capable of supporting. Possible advertisements 904 include, but are not limited to, banner ads, text ads, video ads, audio ads, and targeted ads.

What is claimed is:

1. A computer program product for transferring transcripts, the computer program product comprising computer-readable instructions stored on a computer-readable medium that are executable by a computer having a processor for causing the processor to perform operations of:
receiving a request for a transcript quote from a requestor, the request including case information selected from a group consisting of a case name, a case number, a date and a department/location;
generating a communication to a reporter with the request;
providing the reporter an interface in which the reporter can associate a number of pages with the requested transcript quote;
determining a cost based on a cost factor selected from a group consisting of page count, delivery speed options, number of copies and type of delivery;
generating a communication to the requestor including information, the information selected from a group consisting of cost information, payment information, payment method information;
receiving notification of payment for the transcript;
providing the reporter a work request with delivery information selected from a group of consisting of, due date, delivery location, delivery speed options, number of copies, type of delivery, and address label with pre-printed postage;
receiving a transcript sent communication from the reporter;
transferring transcript fees to the reporter upon receipt of the transcript sent communication;
generating a communication to the requestor containing a transcript sent notification.

2. A computer program product for transferring transcripts as set forth in claim 1, wherein in the operation of providing the reporter with an address label with preprinted postage, the computer program product further includes computer-readable instructions for causing the computer to perform the operation of calculating postage based on the recipient address and current postage rates and generating the address label.

3. A computer program product for transferring transcripts as set forth in claim 1, wherein the transcript sent notification further includes tracking information and the communication to the requester containing a transcript sent notification further includes the tracking information.

4. A computer program product for transferring transcripts as set forth in claim 1, the computer program product further including computer-readable instructions for causing the processor to perform operations of:
generating a transcript tracker, including a plurality of current transcript requests and a plurality of completed transcript requests, whereupon sending of the transcript, the transcript tracker is updated to remove the transcript from the plurality of current transcript requests and transferred to a plurality completed transcript requests.

5. A computer program product for transferring transcripts as set forth in claim 4, the computer program product further including computer-readable instructions for causing the processor to perform operations of:
providing a requestor interface, the requestor interface including a transcript tracker, the transcript tracker including a sub-set of completed transcript requests and a sub-set of current transcript requests.

6. A computer program product for transferring transcripts as set forth in claim 4, the computer program product further including computer-readable instructions for causing the processor to perform operations of:
providing a reporter interface, the reporter interface including a transcript tracker, the transcript tracker including a sub-set of completed transcript requests and a sub-set of current transcript requests.

7. A computer program product for transferring transcripts as set forth in claim 6, wherein the operation of providing the reporter interface, the computer program product further including computer-readable instructions for causing the processor to perform operations of:
further comprising the reporter interface case information field and corresponding prospective requester field, such that upon input of the case information and corresponding prospective requester information, the prospective requestor is provided a communication with an offer providing a quote for the transcript.

8. A system for transferring transcripts, the system having one or more processors that are operable for performing operations of:
receiving a request for a transcript quote from a requestor, the request including case information selected from a group consisting of a case name, a case number, a date and a department/location;
generating a communication to a reporter with the request;
providing the reporter an interface in which the reporter can associate a number of pages with the requested transcript quote;
determining a cost based on a cost factor selected from a group consisting of page count, delivery speed options, number of copies and type of delivery;
generating a communication to the requester including information, the information selected from a group consisting of cost information, payment information, payment method information;
receiving notification of payment for the transcript;
providing the reporter a work request with delivery information selected from a group of consisting of, due date, delivery location, delivery speed options, number of copies, type of delivery, and address label with pre-printed postage;
receiving a transcript sent communication from the reporter;
transferring transcript fees to the reporter upon receipt of the transcript sent communication;
generating a communication to the requestor containing a transcript sent notification.

9. A system for transferring transcripts as set forth in claim 8, wherein performing the operation of providing the reporter with an address label with preprinted postage further comprises the operation of calculating postage based on the recipient address and current postage rates and generating the address label.

10. A system for transferring transcripts as set forth in claim 8, wherein the transcript sent notification further includes tracking information and the communication to the requestor containing a transcript sent notification further includes the tracking information.

11. A system for transferring transcripts as set forth in claim 8, the system being further configured to perform operations of:
generating a transcript tracker, including a plurality of current transcript requests and a plurality of completed transcript requests, whereupon sending of the transcript, the transcript tracker is updated to remove the transcript from the plurality of current transcript requests and transferred to a plurality completed transcript requests.

12. A system for transferring transcripts as set forth in claim 11, the system being further configured to perform operations of:
providing a requester interface, the requestor interface including a transcript tracker, the transcript tracker including a sub-set of completed transcript requests and a sub-set of current transcript requests.

13. A system for transferring transcripts as set forth in claim 11, the system being further configured to perform operations of:
providing a reporter interface, the reporter interface including a transcript tracker, the transcript tracker including a sub-set of completed transcript requests and a sub-set of current transcript requests.

14. A system for transferring transcripts as set forth in claim 13, wherein performing the operation of providing the reporter interface, the reporter interface further comprising a case information field and corresponding prospective requestor field, such that upon input of the case information and corresponding prospective requestor information, the prospective requestor is provided a communication with an offer providing a quote for the transcript.

15. A method for transferring transcripts, the method comprising an act of causing a processor to perform operations of:
receiving a request for a transcript quote from a requestor, the request including case information selected from a group consisting of a case name, a case number, a date and a department/location;
generating a communication to a reporter with the request;
providing the reporter an interface in which the reporter can associate a number of pages with the requested transcript quote;
determining a cost based on a cost factor selected from a group consisting of page count, delivery speed options, number of copies and type of delivery;
generating a communication to the requestor including information, the information selected from a group consisting of cost information, payment information, payment method information;
receiving notification of payment for the transcript;
providing the reporter a work request with delivery information selected from a group of consisting of, due date, delivery location, delivery speed options, number of copies, type of delivery, and address label with pre-printed postage;
receiving a transcript sent communication from the reporter;
transferring transcript fees to the reporter upon receipt of the transcript sent communication;
generating a communication to the requestor containing a transcript sent notification.

16. A method for transferring transcripts as set forth in claim 12, wherein the act of causing a processor to perform operations of providing the reporter with an address label with preprinted postage further comprises an act of calculating postage based on the recipient address and current postage rates and generating the address label.

17. A method for transferring transcripts as set forth in claim 12, wherein the transcript sent notification further includes tracking information and the communication to the requestor containing a transcript sent notification further includes the tracking information.

18. A method for transferring transcripts as set forth in claim 12, further comprising operations of:
generating a transcript tracker, including a plurality of current transcript requests and a plurality of completed transcript requests, whereupon sending of the transcript, the transcript tracker is updated to remove the transcript from the plurality of current transcript requests and transferred to a plurality completed transcript requests.

19. A method for transferring transcripts as set forth in claim 18, further comprising operations of:
providing a requestor interface, the requestor interface including a transcript tracker, the transcript tracker including a sub-set of completed transcript requests and a sub-set of current transcript requests.

20. A method for transferring transcripts as set forth in claim 18, further comprising operations of:
providing a reporter interface, the reporter interface including a transcript tracker, the transcript tracker including a sub-set of completed transcript requests and a sub-set of current transcript requests.

21. A method for transferring transcripts as set forth in claim 20, wherein the act of causing a processor to perform operations of providing the reporter interface, the reporter interface further comprising a case information field and corresponding prospective requester field, such that upon input of the case information and corresponding prospective requestor information, the prospective requester is provided a communication with an offer providing a quote for the transcript.

22. A computer program product for transferring transcripts as set forth in claim 5, wherein the requester interface further includes an advertising element.

23. A computer program product for transferring transcripts as set forth in claim 6, wherein the reporter interface further includes an advertising element.

24. A system for transferring transcripts as set forth in claim 12, wherein the operation of providing the requester interface, the requestor interface further includes an advertising element.

25. A system for transferring transcripts as set forth in claim 13, wherein the operation of providing the reporter interface, the reporter interface further includes an advertising element.

26. A method for transferring transcripts as set forth in claim 19, wherein the operation of providing a requestor interface, the requestor interface further includes an advertising element.

27. A method for transferring transcripts as set forth in claim 20, wherein the operation of providing a reporter interface, the reporter interface further includes an advertising element.
